(19) United States
(12) Patent Application Publication
(10) Pub. No.: US 2026/0278854 A1
(43) Pub. Date: Sep. 17, 2026

(54) SERVER APPARATUS, CONTROL METHOD OF SERVER APPARATUS, AND STORAGE MEDIUM

(71) Applicant: NEC CORPORATION, Tokyo (JP)

(72) Inventor: Noriyuki HIRAMOTO, Tokyo (JP)

(73) Assignee: NEC CORPORATION, Tokyo (JP)

(21) Appl. No.: 19/473,219

(22) PCT Filed: Apr. 26, 2023
(86) PCT No.: PCT/JP2023/016507

§ 371 Date: Oct. 7, 2025

(51) Int. Cl. G06T 11/00; G06T 13/40; G06T 13/80; G06V 10/40; G06V 10/74; G06V 40/16

(52) U.S. Cl. CPC G06T 11/00; G06T 13/40; G06T 13/80; G06V 10/40; G06V 10/74; G06V 40/171; G06V 40/172

(57) ABSTRACT

A server apparatus includes an identification means and an attraction control means. The identification means identifies a participant of an attraction by performing matching processing using biometric information. The attraction control means reflects information of the identified participant in content to be played back in the attraction.

### TECHNICAL FIELD

The present invention relates to a server apparatus, a control method of a server apparatus, and a storage medium.

### BACKGROUND ART

There exists a technology related to the generation of content to be played back in attractions or the like.

For example, Patent Literature 1 describes that an entrant to a predetermined area is made to feel a sense of unity with a character. An image display system disclosed in the document includes a camera that captures an image of the figure and background of an entrant of a theme park who is in front of a mirror apparatus, a server that processes the image of the entrant captured by the camera to generate display data, and a display apparatus that displays the display data generated by the server on the mirror apparatus. The server includes a database that stores image data of characters, and with reference to the database, the server generates display data by replacing a part of the image of the entrant captured by the camera with a part of the image of a character selected by the entrant.

### CITATION LIST

### Patent Literature

[PTL 1] Japanese Unexamined Patent Application Publication No. JP2022-096739

### SUMMARY OF INVENTION

### Technical Problem

As disclosed in Patent Literature 1, it is necessary to enhance the appeal of attractions such as theme parks. In the system disclosed in Patent Literature 1, an image to be provided to a user is generated using a character selected by the user. However, depending on the type of content to be provided to the user, it may not be appropriate to fit the character into the content to be played back. For example, if an animated character is superimposed onto live-action-based content, the resulting content may appear unnatural or incongruous. Therefore, even with the technology disclosed in Patent Literature 1, it is not always possible to provide content that is attractive to users. That is, the technology disclosed in Patent Literature 1 may not be sufficient to improve the satisfaction level of participants of an attraction.

It is a main object of the present invention to provide a server apparatus, a control method of a server apparatus, and a storage medium that contribute to enhancing the satisfaction of participants of the attraction.

### Solution to Problem

According to a first aspect of the present invention, there is provided a server apparatus including: an identification means that identifies a participant of an attraction by performing matching processing using biometric information; and an attraction control means that reflects information of the identified participant in content to be played back in the attraction.

According to a second aspect of the present invention, there is provided a control method of a server apparatus, the control method including: identifying a participant of an attraction by performing matching processing using biometric information; and reflecting information of the identified participant in content to be played back in the attraction.

According to a third aspect of the present invention, there is provided a computer-readable storage medium storing a program causing a computer mounted on a server apparatus to perform processing for: identifying a participant of an attraction by performing matching processing using biometric information; and reflecting information of the identified participant in content to be played back in the attraction.

### Advantageous Effects of Invention

The individual aspects of the present invention provide a server apparatus, a control method of a server apparatus, and a storage medium that contribute to improving the satisfaction of participants of the attraction. It should be noted that the advantageous effect of the present invention is not limited to the above advantageous effect. The present invention may provide other advantageous effects, instead of or in addition to the above advantageous effect.

### BRIEF DESCRIPTION OF THE DRAWINGS

FIG. 1 is a diagram illustrating an outline of an example embodiment.

FIG. 2 is a flowchart illustrating an outline of operation of an example embodiment.

FIG. 3 is a diagram illustrating an example of a schematic configuration of an information processing system according to a first example embodiment.

FIG. 4 is a diagram illustrating an example of a configuration of an attraction according to the first example embodiment.

FIG. 5 is a diagram illustrating an operation of the information processing system according to the first example embodiment.

FIG. 6 is a diagram illustrating an operation of the information processing system according to the first example embodiment.

FIG. 7 is a diagram illustrating an operation of the information processing system according to the first example embodiment.

FIG. 8 is a diagram illustrating an operation of the information processing system according to the first example embodiment.

FIG. 9 is a diagram illustrating an example of a display of a terminal according to the first example embodiment.

FIG. 10 is a diagram illustrating an example of a processing configuration of a server apparatus according to the first example embodiment.

FIG. 11 is a diagram illustrating an example of a user management database according to the first example embodiment.

FIG. 12 is a flowchart illustrating an example of an operation of the server apparatus according to the first example embodiment.

FIG. 13 is a diagram illustrating an example of a hardware configuration of the server apparatus disclosed in the present application.

### Example Embodiment

First, an outline of an example embodiment will be described. In the following outline, various components are denoted by reference characters for the sake of convenience. That is, the following reference characters are used as examples to facilitate the understanding of the present invention. Thus, the description of the outline is not intended to impose any limitations. In addition, unless otherwise specified, an individual block illustrated in the drawings represents a configuration of a functional unit, not a hardware unit. An individual connection line between blocks in the drawings signifies both one-way and two-way directions. An arrow schematically illustrates a principal signal (data) flow and does not exclude bidirectionality. In the present description and drawings, elements that can be described in a like way will be denoted by a like reference character, and redundant description thereof will be omitted as needed.

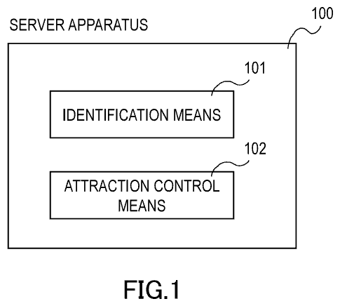

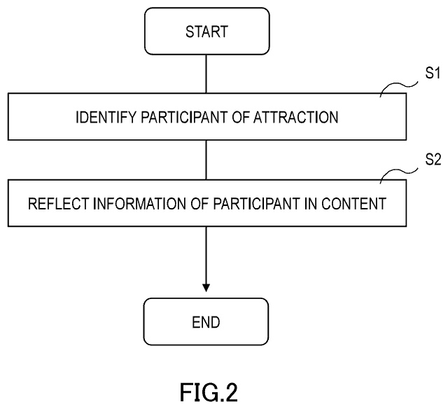

A server apparatus 100 according to an example embodiment includes an identification means 101 and an attraction control means 102 (see FIG. 1). The identification means 101 identifies a participant of an attraction by performing matching processing using biometric information (step S1 in FIG. 2). The attraction control means 102 reflects information of the identified participant in content to be played back in the attraction (step S2).

The server apparatus 100 identifies a participant who visits a theme park and participates in an attraction using biometric authentication (matching processing using biometric information). The server apparatus 10 reflects information of the identified participant (for example, a face image) in content (video data) to be played back in the attraction. As a result, the participant of the attraction is able to obtain a greater sense of immersion in the attraction, since a character having the same face as the participant appears in the content. As a result, the satisfaction level of the participant of the attraction is improved.

Hereinafter, specific example embodiments will be described in more detail with reference to drawings.

### First Example Embodiment

A first example embodiment will be described in more detail with reference to drawings.

### Configuration of System

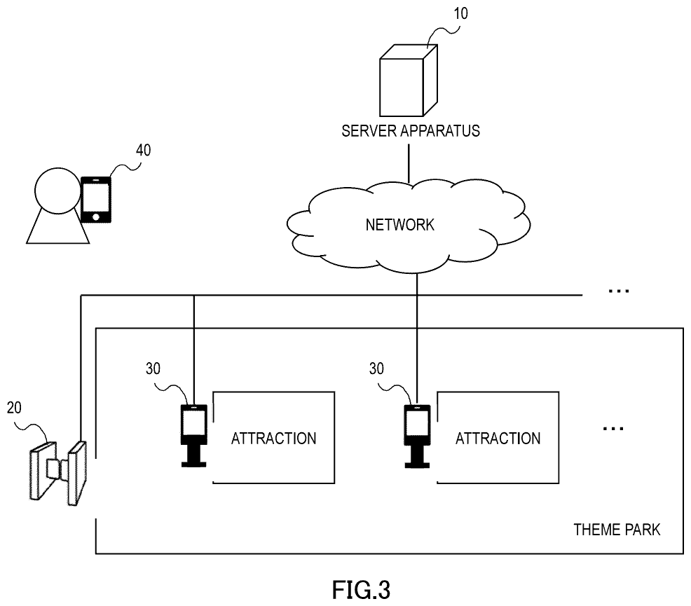

FIG. 3 is a diagram illustrating an example of the schematic configuration of an information processing system (an authentication system or an entertainment system) according to the first example embodiment. The information processing system according to the first example embodiment includes facilities such as a theme park or an amusement park.

As shown in FIG. 3, the information processing system includes a server apparatus 10, an authentication terminal 20, and a guidance terminal 30.

The server apparatus 10 sells tickets and the like for admission to a theme park or the like. In addition, the server apparatus 10 performs admission control for a theme park or the like. Furthermore, the server apparatus 10 performs control related to the content provided at each attraction (amusement facility, performance).

The server apparatus 10 may be installed within the theme park, or it may be installed on a network (on a cloud).

The authentication terminal 20 is, for example, a gate-type apparatus installed at the entrance or exit of the entire theme park. The authentication terminal 20 permits passage of a user who has the authority to enter the theme park and denies passage of a user who does not have such authority.

The guidance terminal 30 is, for example, a signage-type terminal installed at the entrance or exit of each attraction. The guidance terminal 30 presents information such as an explanation of the attraction to the user. In addition, the guidance terminal 30 also functions as a device that detects an entrant of the attraction.

A user possesses a terminal 40. The user operates the terminal 40 to input various types of information into the server apparatus 10. For example, the user accesses the server apparatus 10 by operating the terminal 40 and purchases a ticket required for entering the theme park.

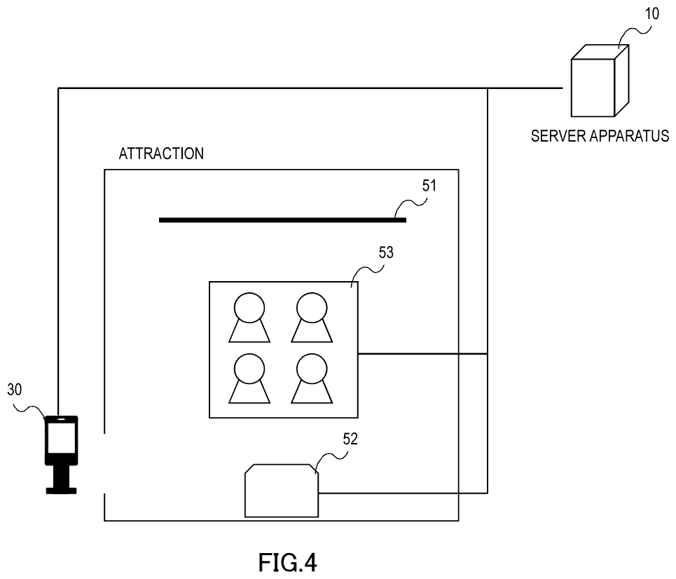

FIG. 4 is a diagram illustrating an example of the internal configuration of an attraction. As shown in FIG. 4, the attraction includes, for example, a screen 51, an image projection apparatus 52, and a vehicle 53.

The user boards the vehicle 53. The vehicle 53 is configured to be capable of movement and vibration. The image projection apparatus 52 projects video content onto the screen 51 in accordance with the progression of the attraction. The vehicle 53 provides the user with vibrations or the like in synchronization with video and music.

The server apparatus 10 performs control of the image projection apparatus 52 and the vehicle 53, such as those described above, to realize the attraction.

Each apparatus shown in FIG. 3 and FIG. 4 is connected to a network. Specifically, the server apparatus 10, the authentication terminal 20, the guidance terminal 30, the terminal 40, and the like are connected to the network via wired or wireless communication means.

The configuration of the information processing system shown in FIG. 3 is an example and is not intended to limit the configuration of the system. For example, a plurality of server apparatuses 10 may be included in the system.

In addition, the configuration or the like of the attraction illustrated in FIG. 4 is merely an example, and it is not intended to limit the configuration or the like of the attraction. For example, the attraction may not include the vehicle 53, and a user may move inside the attraction by their own feet. Alternatively, an attraction that does not require any movement of the user may be provided. The attraction disclosed in the present application may have any configuration or content, as long as it is capable of providing entertainment to the user using video.

### Schematic Operation

Next, a schematic operation of the information processing system according to the first example embodiment will be described.

### Ticket Purchase

A user purchases a ticket in order to enter a theme park. For example, the user operates the terminal 40 to access a website provided by the server apparatus 10. The user purchases the ticket on the website.

At that time, the server apparatus 10 acquires various types of information of the user, including biometric information, name, gender, and contact information (for example, an email address that can be received by the terminal 40). The server apparatus 10 associates and stores the biometric information, contact information, and information of the ticket purchased (ticket information) of the ticket purchaser. The server apparatus 10 stores the biometric information and the like in association with other information in a user management database. Details regarding the user management database will be described below.

Examples of the biometric information include data (feature values) calculated from physical characteristics unique to an individual, such as a face, fingerprint, voiceprint, vein pattern, retina, or iris pattern of the eye. Alternatively, the biometric information may be image data such as a face image or a fingerprint image. The biometric information may be any type of information, as long as it includes physical characteristics specific to an individual. In the present application disclosed, the biometric information is regarded as either a face image of a person or a feature value generated from the face image.

### Entry into Theme Park

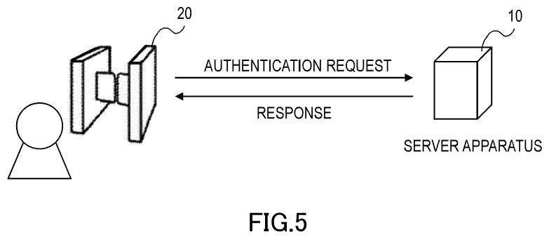

The user enters the theme park by passing through the authentication terminal 20 (a gate apparatus). The authentication terminal 20, upon detecting a user (a person to be authenticated), transmits an authentication request including the biometric information of the person to be authenticated to the server apparatus 10 (see FIG. 5).

Upon receiving the authentication request, the server apparatus 10 performs an authentication processing (1-to-N authentication; where N is a positive integer and the same applies hereinafter) using the biometric information included in the authentication request and the biometric information stored in the user management database.

In a case where the person to be authenticated possesses a valid ticket, the server apparatus 10 notifies the authentication terminal 20 of the authentication success. In such a case, the server apparatus 10 transmits a positive response indicating authentication success to the authentication terminal 20.

In a case where the person to be authenticated does not possess a valid ticket, the server apparatus 10 notifies the authentication terminal 20 of the authentication failure. In this case, the server apparatus 10 transmits a negative response indicating authentication failure to the authentication terminal 20.

The authentication terminal 20 receives an authentication result (authentication success, authentication failure). Upon receiving an authentication success, the authentication terminal 20 opens the gate and permits passage of the person to be authenticated. Upon receiving an authentication failure, the authentication terminal 20 closes the gate and denies passage of the person to be authenticated.

It should be noted that, in the first example embodiment, a case will be described in which the server apparatus 10 authenticates an entrant of the theme park using biometric information of a user. However, the server apparatus 10 may authenticate an entrant of the theme park using other information. For example, the server apparatus 20 may authenticate an entrant of the theme park using a two-dimensional barcode or the like.

### Entry into Attraction

A participant who is going to join the attraction stops in front of the guidance terminal 30 (digital signage) installed at the entrance or exit of the attraction. For example, an employee waiting at each attraction instructs (requests) the participant (the entrant) to stop in front of the guidance terminal 30. At that time, the guidance terminal 30 acquires the biometric information of the participant either in response to an operation by the employee or automatically. For example, the guidance terminal 30 acquires a face image by capturing an image of the participant.

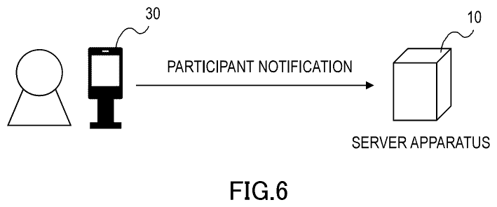

The guidance terminal 30 transmits a “participant notification,” which includes the acquired biometric information and a terminal ID, to the server apparatus 10 (see FIG. 6).

The terminal ID is an identifier for identifying the guidance terminal 30. The terminal ID may employ, for example, the MAC (Media Access Control) address or the IP (Internet Protocol) address of the guidance terminal 30.

It should be noted that the terminal ID is shared between the server apparatus 10 and the guidance terminal 30 by any arbitrary method. For example, a system administrator determines the terminal ID and sets the determined terminal ID in the server apparatus 10. In addition, the system administrator sets the determined terminal ID in the guidance terminal 30.

The server apparatus 10 identifies the participant of the attraction by performing matching processing using the biometric information included in the participant notification and the biometric information registered in the user management database. In addition, the server apparatus 10 identifies the attraction into which the user has entered, based on the terminal ID. The server apparatus 10 stores the information of the identified attraction in the user management database.

### Provision of Attraction

In a case where the user participates (enters) in a specific attraction, the server apparatus 10 generates content of the attraction using the information (for example, a face image) of the participant identified through matching processing. For example, the server apparatus 10 reflects the face image or the like of the identified participant in the content (video data) to be played back in an attraction related to a game or animation.

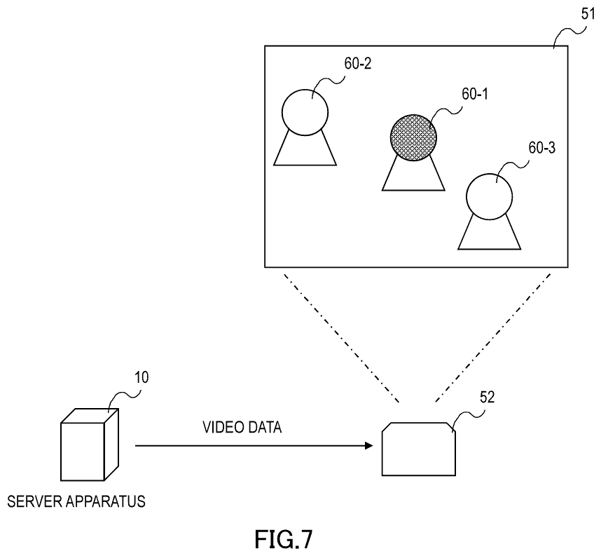

Specifically, as shown in FIG. 7, the server apparatus 10 generates content in which the face image of the identified participant is reflected (that is, the face is substituted) in a character (appearing character). The server apparatus 10 transmits the content (video data), in which the face image of the participant is reflected, to the image projection apparatus 52. The image projection apparatus 52 projects the received video data onto the screen 51.

In the example shown in FIG. 7, among a plurality of characters 60-1 to 60-3 appearing in the content to be played back in the attraction, the face image of the character 60-1 is replaced with the face image of the above-described identified participant.

### Proposal of Product Purchase

After the attraction has ended, the server apparatus 10 suggests the purchase of a product (merchandise) to the user who participated in the attraction that has ended. The server apparatus 10 generates a proposed product or information related to the proposed product to be suggested to the participant of the attraction during the provision of the attraction or after the attraction has ended.

For example, as the proposed product, image data or video data itself in which the information of the participant of the attraction is reflected is exemplified. Alternatively, as the proposed product, merchandise (for example, a mug) created using image data in which information of the participant of the attraction is reflected is exemplified. In this case, an image of a sample in which the above image data is reflected on a mug is the information related to the proposed product.

The server apparatus 10 suggests the purchase of the proposed product to the participant of the attraction.

For example, the server apparatus 10 detects the end of an attraction by referring to the schedule of each attraction. The server apparatus 10 identifies the users who participated in the attraction that has ended.

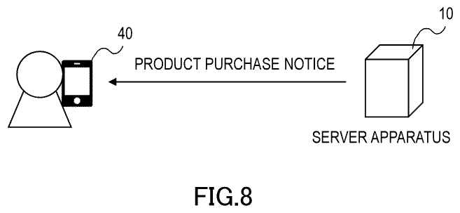

The server apparatus 10 transmits a “product purchase notice” to the terminal 40 possessed by the identified participant (see FIG. 8). The product purchase notice includes information related to a product purchase page dedicated to the participant who participated in the attraction. More specifically, the product purchase notice includes a URL (Uniform Resource Locator) or the like of a product purchase page for purchasing the proposed product in which the face image or the like of each participant of the attraction is reflected.

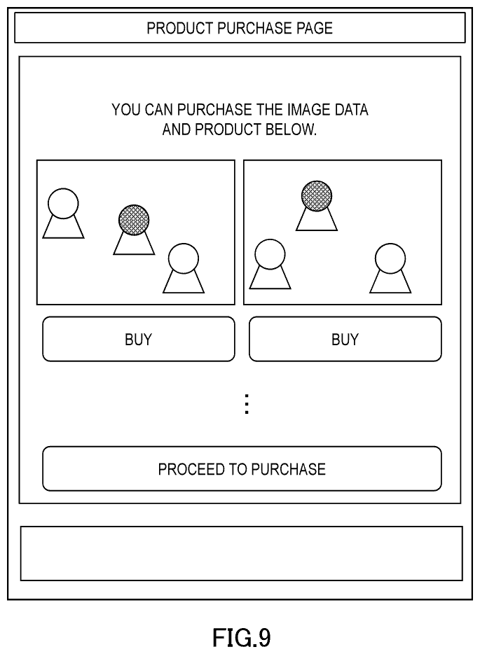

The user operates the terminal 40 to access the above product purchase page. In response to the access of the terminal 40, for example, the server apparatus 10 displays, on the terminal 40, a product purchase page such as that shown in FIG. 9. The user purchases a proposed product (such as image data or a mug cup) that the user prefers on the product purchase page.

Next, details of the individual apparatuses included in the information processing system according to the first example embodiment will be described.

### Server Apparatus

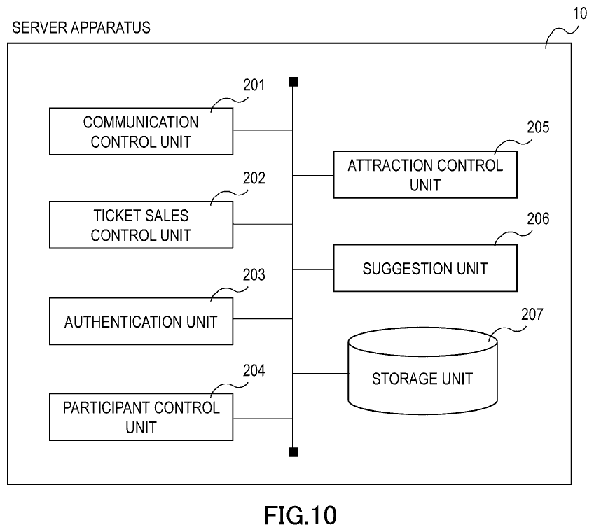

FIG. 10 is a diagram illustrating an example of a processing configuration (processing modules) of the server apparatus 10 according to the first example embodiment. Referring to FIG. 10, the server apparatus 10 includes a communication control unit 201, a ticket sales control unit 202, an authentication unit 203, a participant control unit 204, an attraction control unit 205, a suggestion unit 206, and a storage unit 207.

The communication control unit 201 is means for controlling communication with other apparatuses. For example, the communication control unit 201 receives data (packets) from the authentication terminal 20. In addition, the communication control unit 201 transmits data to the authentication terminal 20. The communication control unit 201 gives data received from other apparatuses to other processing modules. The communication control unit 201 transmits data acquired from other processing modules to other apparatuses. In this way, other processing modules transmit and receive data to and from other apparatuses via the communication control unit 201. The communication control unit 201 includes a function as a receiving unit that receives data from other apparatuses and a function as a transmitting unit that transmits data to other apparatuses.

The ticket sales control unit 202 is means for performing control related to ticket sales.

In a case where a user operates the terminal 40 to access the ticket sales page, the ticket sales control unit 202 sells a ticket to the user on the ticket sales page. The ticket sales control unit 202 generates information of the sold ticket (ticket information; for example, the date of visit to the theme park).

The ticket sales control unit 202 acquires information related to the ticket purchaser in the case of selling a ticket. For example, the ticket sales control unit 202 acquires the name, gender, date of birth, and biometric information (face image) of the ticket purchaser. Alternatively, the ticket sales control unit 202 may acquire information related to a character preferred by the ticket purchaser.

In a case where the information of the ticket purchaser is acquired, the ticket sales control unit 202 generates a user ID for identifying the ticket purchaser. In addition, the ticket sales control unit 202 generates a feature value from the face image acquired from the user.

With respect to the generation processing of the feature value performed by the ticket sales control unit 202, existing techniques can be used, and thus a detailed description thereof will be omitted. For example, the ticket sales control unit 202 extracts the eyes, nose, mouth, or the like as feature points from a face image. Subsequently, the ticket sales control unit 202 calculates, as feature values, the positions of the respective feature points and the distances between the respective feature points (a feature vector composed of a plurality of feature values is generated).

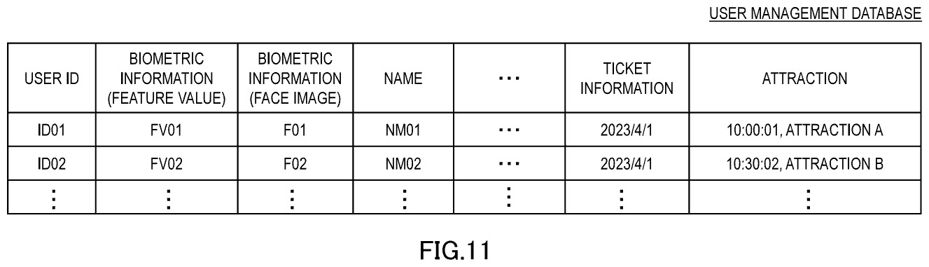

The ticket sales control unit 202 associates and stores a user ID, biometric information (feature values and a face image), name, gender, contact information, ticket information, and the like in a user management database (see FIG. 11). It should be noted that the user management database illustrated in FIG. 11 is merely an example, and it is not intended to limit the items to be stored or other aspects of the database.

The authentication unit 203 is means for performing authentication of a person to be authenticated. Specifically, the authentication unit 203 authenticates an entrant who enters the theme park.

The authentication unit 203 processes an authentication request received from the authentication terminal 20. In a case where the authentication unit 203 receives an authentication request from the authentication terminal 20, the authentication unit 203 performs matching processing using the biometric information included in the authentication request and the biometric information stored in the user management database.

Specifically, the authentication unit 203 generates a feature value from the face image included in the authentication request. The authentication unit 203 sets the generated feature values as the target for matching and performs matching processing (1-to-N matching) with the feature values registered in the user management database.

The authentication unit 203 calculates a similarity between the feature value to be matched and each of the plurality of feature values on the registration side. For the individual similarity, the chi-squared distance, the Euclidean distance, or the like may be used. It should be noted that a longer distance represents a lower similarity, and a shorter distance represents a higher similarity.

The authentication unit 203 determines that the matching processing has failed in a case where none of the plurality of feature values registered in the user management database has a similarity with the feature values set as the target for matching that is equal to or greater than a predetermined value.

In a case where the matching processing fails, the authentication unit 203 transmits a negative response indicating that the authentication of the person to be authenticated has failed, to the authentication terminal 20.

The authentication unit 203 determines that the matching processing has succeeded in a case where, among a plurality of feature values registered in the user management database, there exists a feature value whose similarity with a feature value to be matched is equal to or greater than a predetermined value.

In a case where the matching processing succeeds, the authentication unit 203 identifies the user corresponding to the entry that includes the feature value having the highest similarity as the person to be authenticated (an entrant who enters the theme park). The authentication unit 203 determines whether or not the identified person to be authenticated possesses a valid ticket. For example, the authentication unit 203 determines that the person to be authenticated possesses a valid ticket in a case where the processing date of the authentication request matches the admission date described in the ticket information field.

In a case where the ticket is invalid, the authentication unit 203 transmits a negative response indicating authentication failure to the authentication terminal 20.

In a case where the ticket is valid, the authentication unit 203 transmits a positive response indicating authentication success to the authentication terminal 20.

The participant control unit 204 is means for performing control related to participants who take part in an attraction. For example, the participant control unit 204 processes a participant notification received from the guidance terminal 30. In response to the reception of the participant notification, the participant control unit 204 performs matching processing using biometric information to identify the participant who takes part in the attraction.

Specifically, the participant control unit 204 performs matching processing using the biometric information included in the participant notification and the biometric information stored in the user management database.

In a case where the matching processing succeeds, the participant control unit 204 identifies the attraction into which the entrant has entered based on the terminal ID included in the participant notification. The participant control unit 204 identifies the attraction by referring to table information or the like in which the terminal ID is associated and stored with information such as the name of the attraction.

The participant control unit 204 sets the entry time and the name of the attraction entered in the attraction field of the entry of the user (a participant of the attraction, an entrant of the attraction) identified through the matching processing.

In a case where the matching processing fails, the participant control unit 204 determines that a person who is not registered in the user management database is attempting to enter the attraction. In this case, the participant control unit 204 notifies an administrator of the theme park or a security officer or the like of that situation.

The participant control unit 204 accesses the user management database periodically or at a predetermined timing, and checks the setting value in the attraction field of each entry. In a case where there exists an attraction for which a predetermined period of time has elapsed since the end of the attraction, the participant control unit 204 deletes the information of the attraction from the attraction field.

The attraction control unit 205 is means for performing control related to the realization (provision) of each attraction. The attraction control unit 205 reflects the information of a participant whose participation in the attraction has been identified by the participant control unit 204 in the content to be played back in the attraction.

Upon arrival of the start time of an attraction, the attraction control unit 205 refers to the user management database and identifies the participants of the attraction that is to start. Specifically, the attraction control unit 205 identifies the participants of the attraction based on the setting value in the attraction field of the user management database.

The attraction control unit 205 generates the content to be used in the attraction using the information of the participants who are participating in the attraction. For example, the attraction control unit 205 replaces a face image (a face area) of a person or a character (an appearing person or an appearing character) that appears in the pre-prepared content (video data) with a face image of a participant who is participating in the attraction.

Alternatively, the attraction control unit 205 replaces a face image of a character or the like appearing in the content with a face image of a character preferred by a participant who participates in the attraction.

It should be noted that the attraction control unit 205 may replace a face image of a specific appearing person or the like in the video data (each image data constituting the video data) with a face image of the user by using a face synthesis AI (Artificial Intelligence) technology or the like.

The attraction control unit 205 plays back the generated content (for example, video data in which the face image of a specific character has been replaced with the face image of a participant) from the video projection apparatus 52 as the attraction progresses.

In this manner, the attraction control unit 205 replaces the face image of a character appearing in the content to be played back in the attraction with the information (for example, a face image) of an identified participant that has been identified through matching processing using biometric information.

It should be noted that the attraction control unit 205 may generate the above-described content either before providing the attraction or in real time. In a case where the content is generated in advance, the attraction control unit 205 may generate the above-described content during a period after closing entry to the attraction and before actually providing the attraction.

Here, in a case where a plurality of users participate in the attraction, the attraction control unit 205 may generate the content using various methods.

For example, the attraction control unit 205 may select the user who entered the attraction first as the user whose information is to be reflected in the content.

Alternatively, the attraction control unit 205 may switch the user whose information is to be reflected in the content in accordance with the elapsed time of the content. For example, the attraction control unit 205 may reflect the face image of user A in the content for the first five minutes from the start of the content, and then reflect the face image of user B in the content for the following five minutes.

Alternatively, the attraction control unit 205 may assign a plurality of persons (characters) appearing in the content used in the attraction as targets for reflecting the face images of the participants. For example, in a case where three characters A through C appear in the content, the attraction control unit 205 may respectively reflect the face image of user A onto character A, the face image of user B onto character B, and the face image of user C onto character C.

Alternatively, the attraction control unit 205 may change the user assigned to each of the multiple characters in the content according to the elapsed time.

In addition, the attraction control unit 205 generates image data or video data in which the information (face image) of the participant is reflected in a character appearing in the content during the play back of the content or upon its completion. For example, the attraction control unit 205 extracts image data or video data in which a character, whose face has been replaced with the face of the participant, appears from the content used to provide the attraction.

The attraction control unit 205 associates and stores the user ID of the participant with the image data or video data of a scene in which a character reflecting the participant's information (for example, a face image) appears.

The suggestion unit 206 is means for suggesting the purchase of a product to a participant who participated in the attraction. After the attraction ends, the suggestion unit 206 suggests a purchase of a proposed product to a participant whose face image or the like has been reflected in the content. The proposed product is data (such as image data) that has been generated from content in which the information of a participant of the attraction is reflected, or a product (for example, a mug or the like) that has been created using data generated from content in which the information of the participant of the attraction is reflected.

The suggestion unit 206 identifies the participant who participated in the attraction after the attraction has ended. Specifically, the suggestion unit 206 detects the end of the attraction with reference to the schedule of each attraction. The suggestion unit 206 searches the user management database and identifies the user who participated in the ended attraction.

The suggestion unit 206 generates a proposed product to be suggested to the participant of the attraction and/or information related to the proposed product. Specifically, the suggestion unit 206 generates the extracted image data, sample images of goods in which the image data is reflected, or the like. The suggestion unit 206 generates the proposed product or information related to the proposed product by using the information in which the user ID and the image data, which have been generated by the attraction control unit 205, are associated.

The suggestion unit 206 generates a product purchase page for the participants of the attraction who participated in the attraction that has ended. The product purchase page is generated using the proposed product or information related to the proposed product for each participant.

The suggestion unit 206 suggests the purchase of the proposed product to the participant of the attraction immediately after the attraction has ended. Specifically, the suggestion unit 206 transmits a product purchase notice including the URL or the like of the generated product purchase page to the contact information (an e-mail address that can be received by the terminal 40) of the participant of the attraction.

The suggestion unit 206 displays a product purchase page on the terminal 40 of the user who has accessed in accordance with the URL.

The storage unit 207 is means for storing information necessary for the operation of the server apparatus 10.

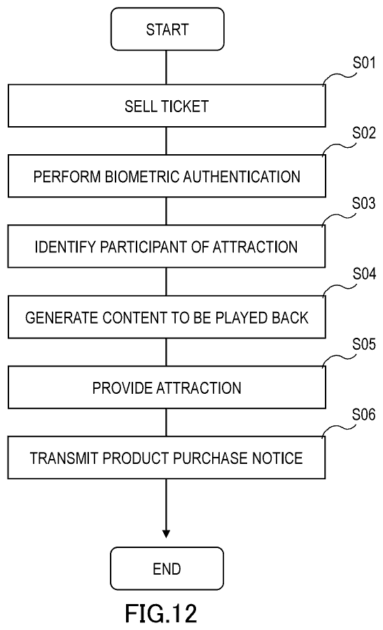

The operation of the server apparatus 10 described above is summarized as shown in the flowchart in FIG. 12.

The server apparatus 10 sells a ticket to a user (step S01). At that time, the server apparatus 10 acquires information such as a face image or a preferred character of the ticket purchaser.

The server apparatus 10 performs biometric authentication in accordance with the reception of an authentication request from the authentication terminal 20 (step S02). The server apparatus 10 notifies the authentication terminal 20 of an authentication result (authentication success, authentication failure).

The server apparatus 10 identifies a participant of the attraction in accordance with the reception of a participant notification from the guidance terminal 30 (step S03).

The server apparatus 10 generates content to be played back in which information (for example, a face image) of a user who participates in the attraction is reflected (step S04). For example, the server apparatus 10 generates content to be played back in which the face of a character appearing in the content is replaced with a face image of the participant of the attraction.

The server apparatus 10 provides the attraction using the generated content (step S05).

After the attraction has ended, the server apparatus 10 transmits a “product purchase notice” to the terminal 40 possessed by the participant of the attraction (step S06).

### Authentication Terminal

The authentication terminal 20 is exemplified by a gate apparatus including a camera apparatus. Since the configuration and the like of the authentication terminal 20 are apparent to those skilled in the art, a detailed description will be omitted. For example, the authentication terminal 20 detects a person to be authenticated in front of the authentication terminal 20 using a sensor or the like. The authentication terminal 20 photographs the detected person to be authenticated and acquires the biometric information (for example, a face image) of the person to be authenticated. The authentication terminal 20 transmits an authentication request including the biometric information (face image) to the server apparatus 10. The authentication terminal 20 may perform processing in accordance with a response (positive response, negative response) from the server apparatus 10.

### Guidance Terminal

An example of the guidance terminal 30 is a digital signage equipped with a camera apparatus. Since the configuration and the like of the guidance terminal 30 are apparent to those skilled in the art, a detailed description will be omitted. For example, the guidance terminal 30 detects a user in front of it using a sensor or the like. The guidance terminal 30 captures the detected user and acquires the biometric information (for example, a face image) of the user (a participant of the attraction). The guidance terminal 30 transmits a “participant notification” including the biometric information (the face image) to the server apparatus 10.

### Terminal

Examples of the terminal 40 include a portable terminal device such as a smartphone, a portable phone, a game console, or a tablet and a computer (a personal computer or a laptop computer). The terminal 40 can be any equipment or device as long as the terminal 30 can accept an operation by a user and can communicate with the server apparatus 10, and so on. In addition, since the configuration and the like of the terminal 40 are apparent to those skilled in the art, a detailed description will be omitted.

Next, variations according to the first example embodiment will be described.

### Variation 1

In the above example embodiment, the operation of the information processing system has been described by taking, as an example, an attraction for which a start time is clearly determined. Here, there also exists an attraction for which the start time is not clearly determined.

In this case, the attraction control unit 205 of the server apparatus 10 may change the timing to play back content in which information of the participant is reflected, in accordance with the timing (time) at which the participant participated in the attraction.

For example, consideration will be given by taking as an example an attraction in which it is known in advance that a participant arrives at a specific point five minutes after entering the attraction. In this case, for example, in a case where the participant enters the attraction at 15:00, the attraction control unit 205 plays back content, at the above-mentioned specific point at 15:05, in which information of the participant (for example, a face image) is reflected.

In addition, in a case where it is known in advance that the attraction ends thirty minutes after the participant enters the attraction, the suggestion unit 206 of the server apparatus 10 only needs to transmit a product purchase notice to the terminal 40 at 15:30.

As described above, the attraction control unit 205 may determine the timing for playing back content in which information of the participant of the attraction is reflected, in accordance with the timing at which the participant of the attraction has entered the facility where the attraction is conducted.

Alternatively, the attraction control unit 205 may determine the timing for playing back content in which the information of the participant is reflected, in accordance with the congestion level of the attraction. Specifically, in a case where the congestion level of the attraction is high, the attraction control unit 205 delays the playback time of the content in which the information of the participant is reflected, as compared with a case where the congestion level of the attraction is low. For example, in a case where the attraction is not crowded (for example, the congestion level is 30% or less, the waiting time is less than ten minutes, or the like), the attraction control unit 205 plays back the content five minutes after the participant enters the attraction. In contrast, in a case where the attraction is crowded (the congestion level is 80% or more, the waiting time is 60 minutes or more), the attraction control unit 205 plays back the content fifty minutes after the participant enters the attraction. It should be noted that the attraction control unit 205 may acquire the congestion level (information related to the congestion level; for example, waiting time) from a staff member who is stationed at the attraction, or may calculate the congestion level based on the analysis result of an image obtained by capturing a queue of people waiting to enter the attraction. In this manner, in a case where the congestion level of the attraction is high, the attraction control unit 205 may extend the time from the entrance of the participant into the attraction until the content is played back.

### Variation 2

The attraction control unit 205 may determine the information of the participant to be reflected in the content to be played back in the attraction, based on the content to be played back in the attraction (the type of content).

For example, in a case where the content to be played back is live-action-based content, the attraction control unit 205 reflects a face image of the participant of the attraction in the content. In a case where the content to be played back is animation-based content, the attraction control unit 205 reflects a favorite character of the participant of the attraction in the content.

### Variation 3

In a case where a plurality of participants is identified at substantially the same time, the attraction control unit 205 may reflect the information of each of the plurality of participants, who have been identified at substantially the same timing, in content that is played back in the attraction at the same timing.

The participant control unit 204 identifies the participant of the attraction by performing matching processing using biometric information of each of the plurality of participants in a case where the plurality of users (participants) appear in a single piece of image data. The participant control unit 204 sets the entrance time of the participants of the attraction, who are identified from the single piece of image data, to the same time.

The attraction control unit 205 determines that a plurality of users having the same entrance time belong to the same group (for example, a family), and reflects the information of the plurality of users on the same screen. For example, the attraction control unit 205 reflects face images of respective members of a family of three onto the faces of three characters 60-1 to 60-3 shown in FIG. 7.

As described above, the server apparatus 10 according to the first example embodiment identifies a participant of the attraction using biometric authentication. The server apparatus 10 reflects information of the identified participant (for example, a face image) in a portion of video content to be played back in the attraction. As a result, the participant of the attraction is able to concentrate on or feel a sense of immersion in the story provided by the attraction, since a character having the same face as the participant appears in the content. As a result, the satisfaction level of the participant of the attraction is improved.

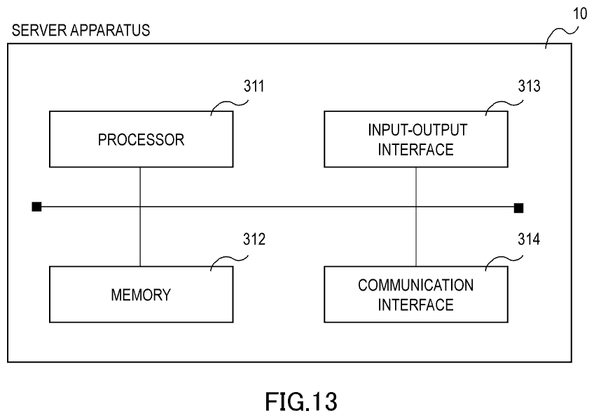

Next, a hardware configuration of an individual apparatus that constitutes the information processing system will be described. FIG. 13 is a diagram illustrating an example of a hardware configuration of the server apparatus 10.

The server apparatus 10 can be configured by an information processing apparatus (a so-called computer) and has a configuration illustrated as an example in FIG. 13. For example, the server apparatus 10 includes a processor 311, a memory 312, an input-output interface 313, a communication interface 314, or the like. The components such as the processor 311 are connected to an internal bus, or the like that these components can communicate with each other.

The hardware configuration of the server apparatus 10 is not limited to the configuration illustrated in FIG. 13. The server apparatus 10 may include hardware not illustrated or may be configured without the input-output interface 313 if desired. In addition, the number of components, such as the number of processors 311, included in the server apparatus 10 is not limited to the example illustrated in FIG. 13. For example, a plurality of processors 311 may be included in the server apparatus 10.

For example, the processor 311 is a programmable device such as a CPU (Central Processing Unit), an MPU (Micro Processing Unit), or a DSP (Digital Signal Processor). Alternatively, the processor 311 may be a device such as an FPGA (Field Programmable Gate Array) or an ASIC (Application Specific Integrated Circuit). The processor 311 executes various kinds of programs including an operating system (OS).

The memory 312 is a RAM (Random Access Memory), a ROM (Read-Only Memory), an HDD (Hard Disk Drive), an SSD (Solid State Drive), or the like. The memory 312 stores an OS program, an application program, and various kinds of data.

The input-output interface 313 is an interface for a display apparatus and an input apparatus not illustrated. The display apparatus is, for example, a liquid crystal display or the like. For example, the input device is a device, such as a keyboard, a mouse or a touch panel which receives user operations.

The communication interface 314 is a circuit, a module, and so on for performing communication with other apparatuses. For example, the communication interface 314 includes a NIC (Network Interface Card) or the like.

The functions of the server apparatus 10 are realized by various kinds of processing modules. The processing modules are realized, for example, by causing the processor 311 to execute a program stored in the memory 312. In addition, this program can be recorded in a computer-readable storage medium. The storage medium may be a non-transient (non-transitory) storage medium, such as a semiconductor memory, a hard disk, a magnetic recording medium, or an optical recording medium. That is, the present invention can be embodied as a computer program product. In addition, the above program may be updated by downloading a program via a network or by using a storage medium in which a program is stored. In addition, the above processing modules may be realized by semiconductor chips.

It should be noted that, as is the case with the server apparatus 10, the authentication terminal 20 or the like can also be configured by an information processing apparatus, and since the basic hardware configuration of the authentication terminal 20 is the same as that of the server apparatus 10, description of the basic hardware configuration of the authentication terminal 20 will be omitted.

The server apparatus 10 includes a computer and can realize its functions by causing the computer to execute a program. In addition, the server apparatus 10 executes a control method of the server apparatus 10 by using this program.

### Variations

It should be noted that the configuration, operation, and the like of the information processing system described in the above example embodiment are illustrative and are not intended to limit the configuration of the system or the like.

In the above example embodiment, it has been described that authentication processing using biometric information is performed in a case where a user enters a theme park or the like. However, authentication of the person to be authenticated may be performed by another method. For example, the server apparatus 10 may issue an ID to a ticket purchaser and may acquire the issued ID from the authentication terminal 20. For example, the server apparatus 10 generates a two-dimensional barcode into which the ID of a ticket purchaser is converted, and transmits the generated two-dimensional barcode to the terminal 40. The terminal 40 displays the two-dimensional barcode in accordance with an operation by the user. The authentication terminal 20 reads the displayed two-dimensional barcode and acquires the ID of the ticket purchaser. The authentication terminal 20 transmits an authentication request including the acquired ID to the server apparatus 10. The server apparatus 10 may identify the person to be authenticated using the ID and determine whether or not the person to be authenticated possesses a valid ticket.

In the above example embodiment, a case has been described in which a ticket for entering each attraction is not required. However, it is also acceptable that a ticket is required for entering each attraction. In this case, the server apparatus 10 sells tickets for each attraction to users. In addition, in this case, the authentication terminal 20 is installed at the entrance and exit of each attraction. The server apparatus 10 may process an authentication request received from the authentication terminal 20 installed at the entrance and exit of each attraction in the same manner as an authentication request transmitted by the authentication terminal 20 installed at the entrance and exit of the entire theme park. In this case, the server apparatus 10 (the authentication unit 203) may store, in the user management database, the time at which authentication is determined to be successful in each attraction and the name of the attraction.

In the above example embodiment, a case has been described in which the server apparatus 10 identifies a target person (a participant of the attraction) to whom a product purchase notice is to be transmitted, based on the schedule of each attraction. The server apparatus 10 may identify the participant of the attraction using a terminal (such as the guidance terminal 30) installed at the exit of each attraction. In this case, the guidance terminal 30 installed at the exit of the attraction transmits a “leaving participant notification” including biometric information of the user to the server apparatus 10. The server apparatus 10 identifies the leaving participant by performing matching processing using the biometric information included in the leaving participant notification and the biometric information stored in the user management database. The server apparatus 10 may transmit the “product purchase notice” to the terminal 40 of the identified leaving participant.

The content provided in the attraction may be common to a plurality of users, or may be content dedicated to each user. For example, in a form in which each participant participates in the attraction while wearing VR (Virtual Reality) goggles, the server apparatus 10 may continuously supply content in which the participant's information is reflected to the VR goggles or the like.

In the above example embodiment, the operation and the like of the information processing system have been described using as an example a system configuration in which the guidance terminal 30 is installed in each attraction. However, the information processing system may not include the guidance terminal 30 installed in each attraction. In this case, the server apparatus 10 authenticates an entrant using the authentication terminal 20 installed at the entrance and exit of the theme park. The server apparatus 10 may determine a timing to play back content in which participant information is reflected, based on the time at which the theme park entrant has passed through the authentication terminal 20, the distance from the entrance and exit of the theme park to the attraction, and the number of entrants waiting in line for the attraction.

In the above example embodiment, a case has been described in which a user management database is configured inside the server apparatus 10, but the database may be constructed in an external database server or the like. That is, some of the functions of the server apparatus 10 may be implemented in another apparatus. More specifically, the “attraction control unit (attraction control means)” or the like described above, can be implemented in any of the apparatuses included in the system.

In the flowcharts and sequence diagrams used in the above description, a plurality of steps (processes) are sequentially described. However, the order of the execution of the steps performed in the individual example embodiment is not limited to the described order. In the individual example embodiment, the order of the illustrated steps may be changed to the extent that a problem is not caused on the content of the individual example embodiment. For example, individual processes may be executed in parallel.

The above example embodiments have been described in detail to facilitate the understanding of the present application disclosed and not to mean that all the configurations described above are needed. In addition, if a plurality of example embodiments have been described, each of the example embodiments may be used individually or a plurality of example embodiments may be used in combination. For example, part of a configuration according to one example embodiment may be replaced by a configuration according to another example embodiment. For example, a configuration according to one example embodiment may be added to a configuration according to another example embodiment. In addition, addition, deletion, or replacement is possible between part of a configuration according to one example embodiment and another configuration.

The industrial applicability of the present invention has been made apparent by the above description. That is, the present invention is suitably applicable, for example, to an information processing system or the like that provides an attraction conducted in a theme park or the like.

A part or the entirety of the example embodiments described above may be described as in the following supplementary notes, but is not limited to the followings.

### Supplementary Note 1

A server apparatus including:
an identification means that identifies a participant of an attraction by performing matching processing using biometric information; and an attraction control means that reflects information of the identified participant in content to be played back in the attraction.

### Supplementary Note 2

The server apparatus according to supplementary note 1, wherein the attraction control means replaces a face image of a character appearing in the content to be played back in the attraction with a face image of the identified participant.

### Supplementary Note 3

The server apparatus according to supplementary note 2, further including a suggestion means that suggests, after the attraction ends, to the participant whose information has been reflected in the content, purchase of data that has been generated from the content in which the information of the participant of the attraction is reflected, or a product that has been created using data generated from the content in which the information of the participant of the attraction is reflected.

### Supplementary Note 4

The server apparatus according to supplementary note 3, wherein the attraction control means determines timing for playing back the content in which the information of the participant of the attraction is reflected, in accordance with timing at which the participant of the attraction has entered a facility where the attraction is conducted.

### Supplementary Note 5

The server apparatus according to supplementary note 4, wherein the attraction control means determines the information of the participant to be reflected in the content to be played back in the attraction, based on the content to be played back in the attraction.

### Supplementary Note 6

The server apparatus according to supplementary note 5, wherein the attraction control means reflects, in a case where a plurality of participants is identified at substantially the same time, information of each of the plurality of participants, who have been identified at substantially the same timing, in content that is played back in the attraction at the same timing.

### Supplementary Note 7

The server apparatus according to any one of supplementary notes 1 to 6, wherein the biometric information is a face image or a feature value generated from the face image.

### Supplementary Note 8

A control method of a server apparatus, the control method including: identifying a participant of an attraction by performing matching processing using biometric information; and reflecting information of the identified participant in content to be played back in the attraction.

### Supplementary Note 9

A computer-readable storage medium storing a program causing a computer mounted on a server apparatus to perform processing for: identifying a participant of an attraction by performing matching processing using biometric information; and reflecting information of the identified participant in content to be played back in the attraction.

The entire disclosure of the above patent literature is incorporated herein by reference thereto. While the example embodiments of the present invention have thus been described, the present invention is not limited to these example embodiments. It is to be understood to those skilled in the art that these example embodiments are only examples and that various variations are possible without departing from the scope and sprit of the present invention. That is, the present invention of course includes various variations and modifications that could be made by those skilled in the art in accordance with the overall disclosure including the claims and the technical concept.

### Reference Signs List

10 server apparatus
20 authentication terminal
30 guidance terminal
40 terminal
51 screen
52 image projection apparatus
53 vehicle
100 server apparatus
101 identification means
102 attraction control means
201 communication control unit
202 ticket sales control unit
203 authentication unit
204 participant control unit
205 attraction control unit
206 suggestion unit
207 storage unit
311 processor
312 memory
313 input-output interface
314 communication interface

What is claimed is:

1. A server apparatus comprising:
at least one memory storing a set of instructions; and
at least one processor configured to execute the set of instructions to:
identify a participant of an attraction by performing matching processing using biometric information; and
reflect information of the identified participant in content to be played back in the attraction.

2. The server apparatus according to claim 1, wherein
the at least one processor is further configured to execute the set of instructions to replace a face image of a character appearing in the content to be played back in the attraction with a face image of the identified participant.

3. The server apparatus according to claim 2, wherein
the at least one processor is further configured to execute the set of instructions to suggest, after the attraction ends, to the participant whose information has been reflected in the content, purchase of data that has been generated from the content in which the information of the participant of the attraction is reflected, or a product that has been created using data generated from the content in which the information of the participant of the attraction is reflected.

4. The server apparatus according to claim 3, wherein
the at least one processor is further configured to execute the set of instructions to determine timing for playing back the content in which the information of the participant of the attraction is reflected, in accordance with timing at which the participant of the attraction has entered a facility where the attraction is conducted.

5. The server apparatus according to claim 4, wherein
the at least one processor is further configured to execute the set of instructions to determine the information of the participant to be reflected in the content to be played back in the attraction, based on the content to be played back in the attraction.

6. The server apparatus according to claim 5, wherein
the at least one processor is further configured to execute the set of instructions to reflect, in a case where a plurality of participants is identified at substantially the same time, information of each of the plurality of participants, who have been identified at substantially the same timing, in content that is played back in the attraction at the same timing.

7. The server apparatus according to claim 1, wherein the biometric information is a face image or a feature value generated from the face image.

8. A control method of a server apparatus, the control method comprising:
identifying a participant of an attraction by performing matching processing using biometric information; and
reflecting information of the identified participant in content to be played back in the attraction.

9. A non-transitory computer-readable storage medium storing a program causing a computer mounted on a server apparatus to perform processing for:
identifying a participant of an attraction by performing matching processing using biometric information; and
reflecting information of the identified participant in content to be played back in the attraction.
